(19) United States
(12) Patent Application Publication
(10) Pub. No.: US 2017/0262256 A1
(43) Pub. Date: Sep. 14, 2017

(54) ENVIRONMENT BASED ENTERTAINMENT

(71) Applicant: Panasonic Automotive Systems Company of America, Division of Panasonic Corporation of North Americ, Peachtree City, GA (US)

(72) Inventors: SHANTHA KUMARI RAJENDRAN, Farmington Hills, MI (US); Harsha V. Injeti, Fayetteville, GA (US)

(73) Assignee: Panasonic Automotive Systems Company of America, Division of Panasonic Corporation of North Americ

(21) Appl. No.: 15/452,125

(22) Filed: Mar. 7, 2017

Related U.S. Application Data
(60) Provisional application No. 62/306,130, filed on Mar. 10, 2016.

(51) Int. Cl. G06F 3/16; H04R 3/00; G06F 17/30; G10L 25/63

(52) U.S. Cl. CPC G06F 3/165; G10L 25/63; H04R 3/00; G06F 17/30764; H04R 2499/13

(57) ABSTRACT

A motor vehicle includes a source of pieces of music. Each of the pieces of music is associated with respective weather conditions and/or a respective emotional mood. The vehicle includes a source of weather data. The weather data is related to weather conditions in which the motor vehicle is operating. The vehicle includes a source of mood data. The mood data is related to an emotional state of a human user disposed within the motor vehicle. A loudspeaker is disposed within a passenger compartment of the motor vehicle. A processing device is communicatively coupled to each of the source of pieces of music, the source of weather data, the source of mood data, and the loudspeaker. The processing device selects one of the pieces of music dependent upon the weather data and the mood data, and plays the selected piece of music on the loudspeaker.

CROSS-REFERENCED TO RELATED APPLICATIONS

This application claims benefit of U.S. Provisional Application No. 62/306,130 filed on Mar. 10, 2016, which the disclosure of which is hereby incorporated by reference in its entirety for all purposes.

### FIELD OF THE INVENTION

The disclosure relates to the field of audio systems, and, more particularly, to audio systems in motor vehicles.

### BACKGROUND OF THE INVENTION

Currently, songs played by a vehicle's entertainment unit do not always match the current scenario/environment. Songs that are played may not suit the mood of the users. For example, a sad song may he played when a user is happy.

### SUMMARY

The present invention may enable ear users to listen to songs based on their environment. Weather conditions and/or the user's mood as identified based on words he uses and/or emojis he selects may be the basis on which a song is selected to provide entertainment based on the current environment. For example, rain related pleasant songs may be played on a rainy day. When the user presses a sad smiley (emoji icon) on the car radio unit, then some sad melodies and/or lyrics may be played. The user may also be provided with a settings option enabling him to play happy songs when he is sad. Different audio sources such as AM, FM, Satellite Radio, Internet Radio, Bluetooth Streaming Audio, or Media devices (CD, USB, SD card, iPod, etc.) may he searched for a song matching the user's current mood and that is to be played for the user.

In one embodiment, the invention comprises a motor vehicle including a source of pieces of music. Each of the pieces of music is associated with respective weather conditions and/or a respective emotional mood. The vehicle includes a source of weather data. The weather data is related to weather conditions in which the motor vehicle is operating. The vehicle includes a source of mood data. The mood data is related to an emotional state of a human user disposed within the motor vehicle. A loudspeaker is disposed within a passenger compartment of the motor vehicle. A processing device is communicatively coupled to each of the source of pieces of music, the source of weather data, the source of mood data, and the loudspeaker. The processing device selects one of the pieces of music dependent upon the weather data and the mood data, and plays the selected piece of music on the loudspeaker.

In another embodiment, the invention comprises a method of operating an audio system in a motor vehicle, including providing a source of pieces of music. Each of the pieces of music is associated with respective weather conditions and/or a respective emotional mood. A source of weather data is provided. The weather data is related to weather conditions in which the motor vehicle is operating. A source of mood data is provided. The mood data is related to an emotional state of a human user who is disposed within the motor vehicle. A loudspeaker is provided within a passenger compartment of the vehicle. One of the pieces of music is automatically selected by an electronic processing device dependent upon the weather data and the mood data. The selected piece of music is played on the loudspeaker.

In yet another embodiment, the invention comprises a motor vehicle including a source of pieces of music. Each of the pieces of music is associated with a respective first emotional mood. The motor vehicle includes a source of weather data. The weather data is related to weather conditions in which the motor vehicle is operating. The motor vehicle includes a source of mood data. The mood data is related to a second emotional mood of a human user disposed within the motor vehicle. A loudspeaker is disposed within a passenger compartment of the motor vehicle. A processing device is communicatively coupled to each of the source of pieces of music, the source of weather data, the source of mood data, and the loudspeaker. The processing device associates the weather conditions with a respective third emotional mood. The processing device selects one of the pieces of music associated with a first emotional mood such that the first emotional mood matches the second emotional mood and/or the third emotional mood. The processing device plays the selected piece of music on the loudspeaker.

An advantage of the present invention is that it may enable users to match entertainment that is played to the current environment.

### BRIEF DESCRIPTION OF THE DRAWINGS

A better understanding of the present invention will be had upon reference to the following description in conjunction with the accompanying drawings.

FIG. 1 is a block diagram of one embodiment of a vehicular environment based entertainment arrangement of the present invention.

FIG. 2 is a flow chart of one embodiment of a vehicular environment based entertainment method of the invention.

FIG. 3 is a flow chart of one embodiment of a method of the invention for operating an audio system in a motor vehicle.

### DETAILED DESCRIPTION OF THE PREFERRED EMBODIMENTS

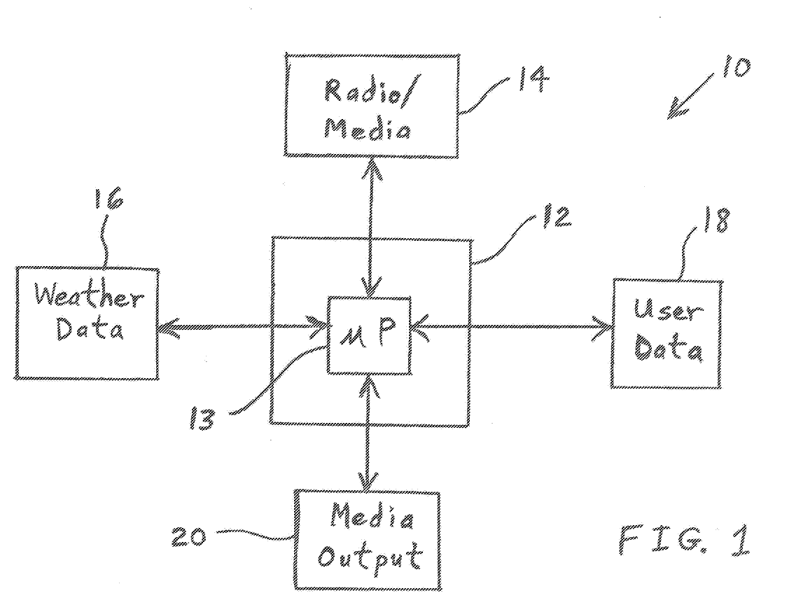

FIG. 1 illustrates one embodiment of a vehicular environment based entertainment arrangement 10 of the present invention including an infotainment unit 12 having an electronic processor 13 in bi-directional communication with each of a radio/media audio source 14, a source of weather data 16, a source of user data 18, and a media output 20. Radio media audio source 14 may be a source of songs or other pieces of music each stored in association with an emotional theme, such as happy, sad, melancholy, mellow, etc. Each of the pieces of music may also be stored in association with respective weather conditions that match an emotional mood of the music. Radio/media audio source 14 may include various audio sources such as AM, FM, Satellite Radio, Internet Radio, Bluetooth Streaming Audio, or Media devices (CD, USB, SD card, iPod, etc.).

Weather data source 16 may be radio based or internet based, or may be in the form of one or more sensors on the vehicle. For example, a light sensor, temperature sensor and moisture sensor, which are often already included in modern vehicles, may he used for determining current weather conditions. Music may be selected based on the determined weather conditions within the scope of the invention.

User data source 18 may be in communication with the user's mobile phone, an in-vehicle voice recognition module, and/or a user interface disposed on the dashboard, console and/or steering wheel. User data source 18 may detect words used by the driver or passenger during texts, entails and/or voice conversations. User data source 18 may also be in the form of a facial recognition module that can determine the user's mood based on the expression on his face. In this way, processor 13 may detect the mood or mental state of the user without the user being consciously aware that such detecting is occurring. User data source 18 may also detect emoji pushbuttons pressed by the user on the user interface. Each emoji may represent a different mood or emotion, as is well known. In this way, processor 13 may detect the mood or mental state of the user with the user being consciously aware that such detecting is occurring because the user intentionally communicates his mood or emotion.

Processor 13 may process the weather data from source 16 and the mood data from source 18 and select a piece of music from audio source 14 that matches the user's mood, which may be predictably affected by the weather conditions. Alternatively, a happy piece of music may be selected from audio source 14 that is intended to improve a poor or unhappy mood of the user. Whether music is played that matches (one mode of operation) or improves (another mode of operation) a user's unhappy or melancholy mood may be selectable by the user. Alternatively, which of these two modes is implemented may be switched automatically from one mode to the other in response to the user skipping or otherwise rejecting music that has been selected by one of the above two modes. The selected piece of music may be played on media output 20, which may be a loudspeaker, for example.

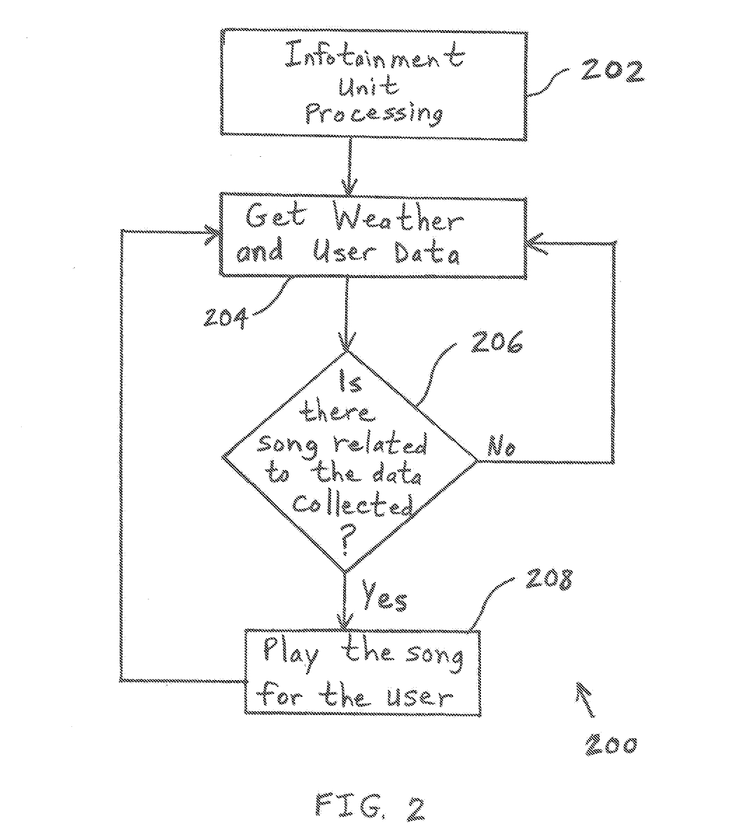

FIG. 2 illustrates one embodiment of a vehicular environment based entertainment method 200 of the invention. In a first step 202, infotainment unit processing occurs. For example, the currently playing song may be retrieved from memory and played on a loudspeaker.

Next, in step 204, weather and user data is collected. Current weather conditions may be received by processor 13 from weather data source 16, and processor 13 may determine the user's mood based on data collected from user data source 18, which may include the user's mobile phone, an in-vehicle voice recognition module, and/or a user interface.

In a next step 206, it is determined whether there is a piece of music available that is related to the data collected from weather data source 16 and user data source 18. For example, processor 13 may search radio/media audio source 14 for a piece of music that matches in terms of melody, beat and/or lyrics a mood likely created by the weather conditions and/or a mood indicated by the inputs from user data source 18. In another mode of operation, processor 13 may search radio/media audio source 14 for a piece of music that is lively, bouncy or upbeat in melody, beat and/or lyrics in an attempt to improve a dour mood likely created by cloudy/rainy weather conditions and/or indicated by the inputs from user data source 18.

If the searched for piece of music cannot be found or is not available, then operation returns to step 204. Conversely, if the searched for piece of music can be found and is available, then operation proceeds to a final step 208, wherein the found piece of music is played for the user, such as on media output 20.

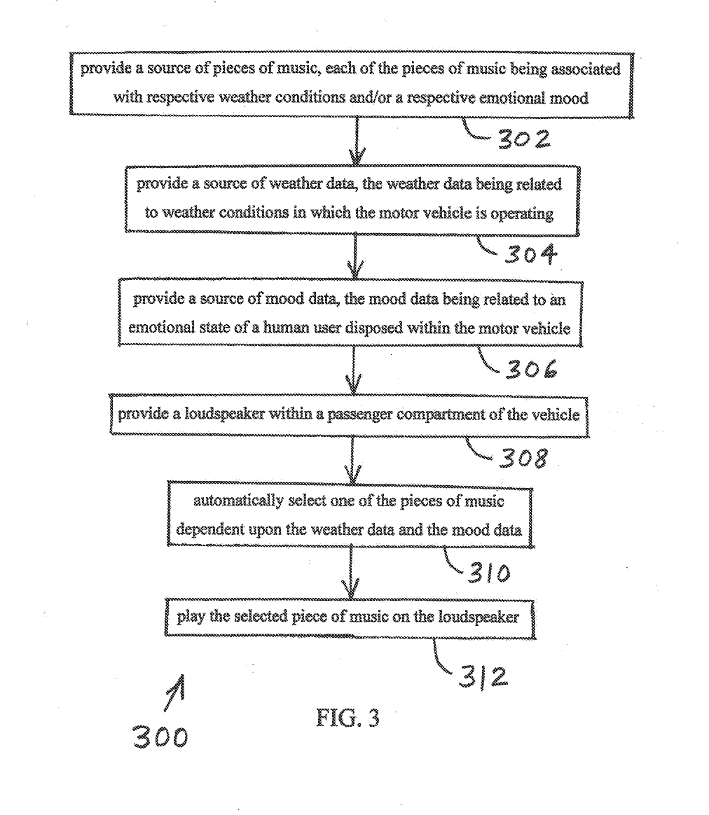

FIG. 3 illustrates one embodiment of a method 300 of the invention for operating an audio system in a motor vehicle. In a first step 302, a source of pieces of music is provided. Each of the pieces of music is associated with respective weather conditions and/or a respective emotional mood. For example, a radio/media audio source 14 may be installed in a motor vehicle, wherein source 14 provides songs or other pieces of music. Each piece of music may have an identified association with a particular emotional theme, such as happy, sad, melancholy, mellow, etc. The emotional theme or mood of the music may be subjectively identified, or may be objectively identified, such as by a music analysis algorithm. Each of the pieces of music may also have an identified association with a respective set of weather conditions that match an emotional mood of the music. The matchings of sets of weather conditions with emotional moods may be predetermined subjectively via human judgment, or more objectively by use of empirical data regarding how weather affects mood.

In a next step 304, a source of weather data is provided. The weather data is related to weather conditions in which the motor vehicle is operating. For example, a weather data source 16 may be provided which is radio based or interne based, or may be in the form of one or more sensors on the vehicle. For example, a light sensor, temperature sensor and moisture sensor may determine current weather conditions surrounding the vehicle.

Next, in step 306, a source of mood data is provided. The mood data is related to an emotional state of a human user disposed within the motor vehicle. For example, data regarding a user's mood may be received from user data source 18, which may be in communication with the user's mobile phone, an in-vehicle voice recognition module, and/or a user interface disposed on the dashboard, console and/or steering wheel. User data source 18 may determine what words are used by the driver and/or passengers in texts, emails and/or audible conversations. User data source 18 may also sense emoji pushbuttons pressed by the user on the user interface. Each emoji may represent a different mood or emotion. By analyzing the emojis and words used by the user and/or passengers, processor 13 may detect the mood or mental state of the user.

In step 308, a loudspeaker is provided within a passenger compartment of the vehicle. For example, media output 20 may be in the form of a loudspeaker mounted within a passenger compartment of the vehicle.

In a next step 310, one of the pieces of music is automatically selected dependent upon the weather data and the mood data. For example, processor 13 may search radio media audio source 14 for a piece of music that matches in terms of melody, beat and/or lyrics a mood likely created by the weather conditions and/or a mood indicated by the inputs from user data source 18. Such matches may have been predetermined, and the mood the piece of music may be stored in association with the piece of music to thereby reduce the need for real-time analysis of the music.

In a final step 312, the selected piece of music is played on the loudspeaker. For example, media output 20 may include a loudspeaker on which the music is audibly played.

The invention has been described herein as recognizing a user's mood based on words he uses and/or emojis he selects. It is also possible within the scope of the invention to use facial recognition to determine his mood. For example, if the user has sad facial expressions, then happy or sad melody songs can be played to soothe the user. It is also possible within the scope of the invention to ascertain the user's mood based on the words he speaks, as determined via voice recognition. If it is determined that the users are laughing, based on voice recognition, then happy songs may be played to add to the mood.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A motor vehicle, comprising:
a source of pieces of music, each of the pieces of music being associated with respective weather conditions and/or a respective emotional mood;
a source of weather data, the weather data being related to weather conditions in which the motor vehicle is operating;
a source of mood data, the mood data being related to an emotional state of a human user disposed within the motor vehicle;
a loudspeaker disposed within a passenger compartment of the motor vehicle; and
a processing device communicatively coupled to each of the source of pieces of music, the source of weather data, the source of mood data, and the loudspeaker, the processing device being configured to:
select one of the pieces of music dependent upon the weather data and the mood data; and
play the selected piece of music on the loudspeaker.

2. The motor vehicle of claim 1 wherein each of the pieces of music is stored in association with the respective weather conditions and/or the respective emotional mood.

3. The motor vehicle of claim 1 wherein the source of mood data includes:
a microphone disposed within a passenger compartment of the vehicle; and
a voice recognition module communicatively coupled to the microphone and configured to identify words spoken by the user and detected by the microphone, wherein the processing device is configured to discern the emotional state of the user dependent upon the identified words spoken by the user.

4. The motor vehicle of claim 1 wherein the source of mood data includes a user interface enabling the user to manually enter input indicating his emotional state.

5. The motor vehicle of claim 1 wherein the source of mood data includes the user's mobile phone, the processing device being configured to discern the emotional state of the user dependent upon words inputted by the user into his mobile phone via text message or speech.

6. The motor vehicle of claim 1 wherein the source of mood data includes a facial recognition module.

7. The motor vehicle of claim 1 wherein the processing device is configured to respond to the weather data indicating an unhappy emotional mood and/or the mood data indicating an unhappy emotional mood by selecting one of the pieces of music that is associated with a happy emotional mood by virtue of the piece of music having a relatively fast tempo or lyrics indicating that the singer of the lyrics is happy.

8. A method of operating an audio system in a motor vehicle, the method comprising:
providing a source of pieces of music, each of the pieces of music being associated with respective weather conditions and/or a respective emotional mood;
providing a source of weather data, the weather data being related to weather conditions in which the motor vehicle is operating;
providing a source of mood data, the mood data being related to an emotional state of a human user disposed within the motor vehicle;
providing a loudspeaker within a passenger compartment of the vehicle;
automatically selecting one of the pieces of music dependent upon the weather data and the mood data; and
playing the selected piece of music on the loudspeaker.

9. The method of claim 8 further comprising storing each of the pieces of music in association with the respective weather conditions and/or the respective emotional mood.

10. The method of claim 8 further comprising:
providing a microphone disposed within a passenger compartment of the vehicle;
identifying words spoken by the user and detected by the microphone; and
discerning the motional state of the user dependent upon the identified words spoken by the user,

11. The method of claim 8 further comprising the user manually entering input indicating his emotional state into a user interface.

12. The method of claim 8 further comprising discerning the emotional state of the user dependent upon words inputted by the user into his mobile phone via text message or speech.

13. The method of claim 8 further comprising discerning the emotional state of the user dependent upon an output of a facial recognition module.

14. The method of claim 8 wherein the automatically selecting step includes responding to the weather data indicating an unhappy emotional mood and/or the mood data indicating an unhappy emotional mood by selecting one of the pieces of music that is associated with a happy emotional mood by virtue of the piece of music having a relatively fast tempo or lyrics indicating that the singer of the lyrics is happy.

15. A motor vehicle, comprising:
a source of pieces of music, each of the pieces of music being associated with a respective first emotional mood;
a source of weather data, the weather data being related to weather conditions in which the motor vehicle is operating;
a source of mood data, the mood data being related to a second emotional mood of a human user disposed within the motor vehicle;
a loudspeaker disposed within a passenger compartment of the motor vehicle; and
a processing device communicatively coupled to each of the source of pieces of music, the source of weather data, the source of mood data, and the loudspeaker, the processing device being configured to:
associate the weather conditions with a respective third emotional mood;
select one of the pieces of music associated with a first emotional mood such that the first emotional mood matches the second emotional mood and/or the third emotional mood; and
play the selected piece of music on the loudspeaker.

16. The motor vehicle of claim 15 wherein each of the pieces of music is stored in association with the respective first emotional mood.

17. The motor vehicle of claim 15 wherein the source of mood data includes:
a microphone disposed within a passenger compartment of the vehicle; and
a voice recognition module communicatively coupled to the microphone and configured to identify words spoken by the user and detected by the microphone, wherein the processing device is configured to discern the second emotional state of the user dependent upon the identified words spoken by the user.

18. The motor vehicle of claim 15 wherein the source of mood data includes the user's mobile phone, the processing device being configured to discern the emotional state of the user dependent upon words inputted by the user into his mobile phone via text message or speech.

19. The motor vehicle of claim 15 wherein the source of mood data includes a facial recognition module.

20. The motor vehicle of claim 15 wherein the processing device is configured to respond to the weather data indicating a happy emotional mood and/or the mood data indicating a happy emotional mood by selecting one of the pieces of music that is associated with a happy emotional mood by virtue of the piece of music having a relatively fast tempo or lyrics indicating that the singer of the lyrics is happy.
